(19) United States
(12) Patent Application Publication
(10) Pub. No.: US 2015/0208010 A1
(43) Pub. Date: Jul. 23, 2015

(54) IMAGE SENSOR AND IMAGE PROCESSING SYSTEM INCLUDING THE SAME

(71) Applicant: Samsung Electronics Co., Ltd., Suwon-Si (KR)

(72) Inventors: Tae Chan KIM, Yongin-si (KR); Jung Hoon JUNG, Hwaseong-si (KR)

(21) Appl. No.: 14/603,428

(22) Filed: Jan. 23, 2015

(30) Foreign Application Priority Data
Jan. 23, 2014 (KR) 10-2014-0008580

(51) Int. Cl. H04N 5/378; H04N 5/357; H04N 5/376

(52) U.S. Cl. CPC H04N 5/378; H04N 5/376; H04N 5/357

(57) ABSTRACT

An image sensor includes a plurality of pixel groups each of which includes pixels corresponding to at least two row lines among a plurality of row lines in a pixel array, a readout block configured to read out pixel signals output from the pixels in each of the pixel groups, and a row driver configured to control an operation of the pixel groups. The row lines are differently spaced according to position information of the pixels.

### CROSS-REFERENCE TO RELATED APPLICATIONS

This application claims priority under 35 U.S.C. §119(a) from Korean Patent Application No. 10-2014-0008580 filed on Jan. 23, 2014, the disclosure of which is hereby incorporated by reference in its entirety.

### BACKGROUND

Embodiments of the inventive concepts relate to an image sensor and/or an image processing system including the same.

A fisheye lens is used to acquire a wider viewing angle than standard lenses and is being used in various fields. When an image picked up using such a fisheye lens is read out, an image sensor reads out both the center and the fringe of the image at the same resolution even though the resolution of the fringe of the image is less important than that of the center of the image. Moreover, the fringe of the image has distortion and a processor requires line memory for the distortion in order to generate a corrected image.

### SUMMARY

According to some embodiments of the inventive concepts, there is provided an image sensor including a plurality of pixel groups each of which includes pixels corresponding to at least two row lines among a plurality of row lines in a pixel array, a readout block configured to read out pixel signals output from the pixels in each of the pixel groups, and a row driver configured to control an operation of the pixel groups. The row lines are differently spaced according to position information of the pixels.

The pixel groups may include a first pixel group and a second pixel group and a gap between row lines in the first pixel group may be wider than a gap between row lines in the second pixel group.

The row lines corresponding to the first pixel group may correspond to a fringe of an image picked up by a lens and the row lines corresponding to the second pixel group may correspond to a center of the image.

According to other embodiments of the inventive concepts, there is provided an image processing system including the above-described image sensor and an image processor configured to control an operation of the image sensor.

The image processor may include a distortion corrector configured to eliminate distortion in pixel signals output from the readout block. The distortion corrector may be configured to correct the distortion in the pixel signals using different compensation values according to the position information of the pixel signals based on an algorithm.

The image processing system may be a mobile telephone.

According to further embodiments of the inventive concepts, there is provided an image sensor including a plurality of pixel groups each of which includes pixels corresponding to at least two row lines among a plurality of row lines in a pixel array, a readout block configured to read out pixel signals output from the pixels in each of the pixel groups, and a column driver configured to control an operation of the readout block. The readout block controls readout of the pixel signals based on position information of the pixels.

The pixel groups may include a first pixel group and a second pixel group. The readout block may include a switching unit between row lines corresponding to the first pixel group and a first readout circuit. Row lines corresponding to the second pixel group may be directly connected to a second readout circuit.

The switching unit may include at least two switches. At least one of at least two row lines among the row lines corresponding to the first pixel group may be respectively connected to the first readout circuit through a respective one of the at least two switches.

The row lines corresponding to the first pixel group may correspond to a fringe of an image picked up by a lens and the row lines corresponding to the second pixel group may correspond to a center of the image.

The column driver may output a switch control signal for turning off the at least two switches when the lens is a fisheye lens and the column driver may output a switch control signal for turning on the at least two switches when the lens is a normal lens.

According to other embodiments of the inventive concepts, there is provided an image processing system including the above-described image sensor and an image processor configured to control an operation of the image sensor.

The image processor may include a distortion corrector configured to eliminate distortion in pixel signals output from the readout block. The distortion corrector may be configured to correct the distortion in the pixel signals using different compensation values according to the position information of the pixel signals based on an algorithm.

The image processing system may be a digital single-lens reflex (DSLR) camera.

An image sensor includes a first group of pixels; a second group of pixels, the second group of pixels being in a different location of a pixel array than the first group of pixels; a plurality of row lines in the pixel array; and a readout block configured to readout pixel signals output from the pixel array. One of (1) the plurality of row lines and (2) the readout block has a different structure associated with the first group of pixels than the second group of pixels.

In one embodiment, row lines of the plurality of row lines associated with the first pixel group are spaced apart wider than row lines of the plurality of the row lines associated with the second pixel group.

In one embodiment, the row lines associated with the first pixel group correspond to a fringe of an image picked up by a lens and the row lines associated with the second pixel group correspond to a center of the image.

In one embodiment the readout circuit includes a first readout circuit associated with the first group of pixels; a second readout circuit associated with the second pixel group, the row lines associated with the second group of pixels being directly connected to the second readout circuit; and a switching structure configured to selectively connect some of the row lines associated with the first pixel group to the first readout circuit.

In one embodiment, the row lines associated with the first pixel group correspond to a fringe of an image picked up by a lens and the row lines associated with the second pixel group correspond to a center of the image.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a block diagram of an image processing system including an image sensor according to some embodiments of the inventive concepts;

FIG. 2 is a block diagram showing a readout block illustrated in FIG. 1;

FIG. 3 is a block diagram showing a connection between a pixel array and a readout block illustrated in FIG. 2 according to some embodiments of the inventive concepts;

FIG. 4 is a block diagram showing a connection between the pixel array and the readout block illustrated in FIG. 2 according to another embodiment of the inventive concepts;

FIG. 5 is a block diagram of an electronic system including an image sensor illustrated in FIG. 1 according to some embodiments of the inventive concepts; and

FIG. 6 is a block diagram of an electronic system including an image sensor illustrated in FIG. 1 according to another embodiment of the inventive concepts.

### DETAILED DESCRIPTION OF THE EMBODIMENTS

The inventive concepts now will be described more fully hereinafter with reference to the accompanying drawings, in which example embodiments are shown. The example embodiments may, however, be embodied in many different forms and should not be construed as limited to those set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” “includes” and/or “including” or “have” and/or “having” when used in this specification, specify the presence of stated features, regions, integers, steps, operations, elements, and/or components, but do not preclude the presence or addition of one or more other features, regions, integers, steps, operations, elements, components, and/or groups thereof

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present disclosure, and will not be interpreted in an idealized or overly formal sense unless expressly so defined herein.

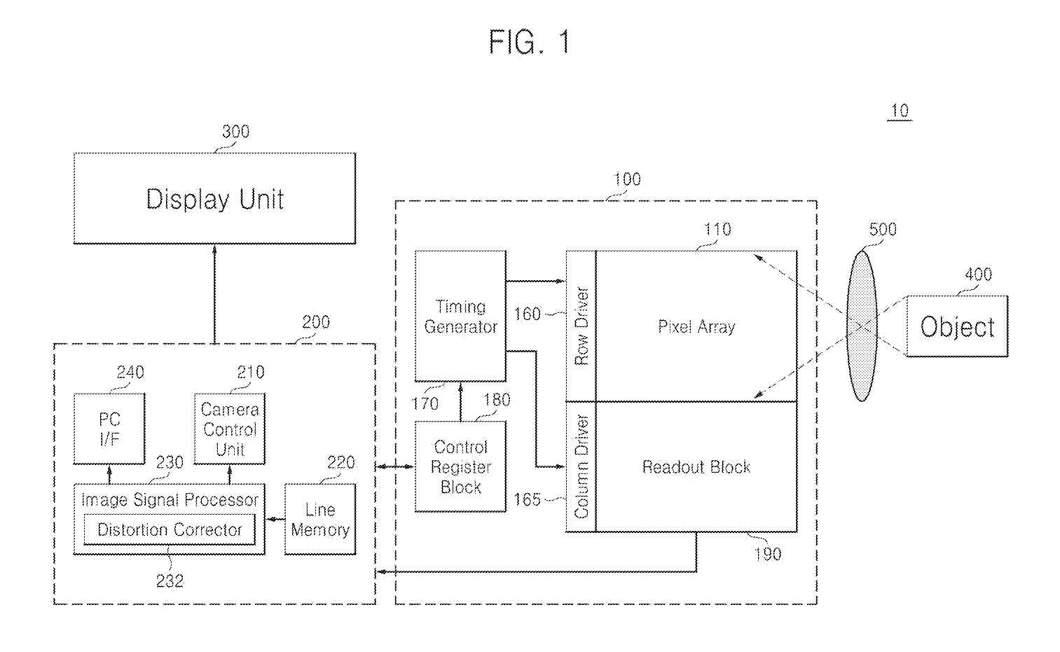

FIG. 1 is a block diagram of an image processing system 10 including an image sensor 100 according to some embodiments of the inventive concepts. The image processing system 10 may include the image sensor 100, an image processor 200, a display unit 300, and a lens 500. The image processing system 10 may be implemented as a mobile camera, a digital single-lens reflex (DSLR) camera, a tablet, or any other image output terminal.

The image sensor 100 may include a pixel array 110, a row driver 160, a column driver 165, a timing generator 170, a control register block 180, and a readout block 190. The image sensor 100 senses an object 400 captured through the lens 500 according to the control of the image processor 200. At this time, the lens 500 may be a wide-angle lens or a fisheye lens, but the inventive concepts are not restricted to these examples.

The pixel array 110 includes a plurality of photo sensitive devices such as photo diodes or pinned photo diodes. The pixel array 110 senses light using the photo sensitive devices and converts the light into electrical signals to generate pixel signals.

The row driver 160 drives the pixel array 110 in row units. In other words, pixels in one row may be driven with the same control signal. In detail, the row driver 160 may decode a control signal output from the timing generator 170 and then applies the control signal to each of rows in the pixel array 110. The pixel array 110 outputs a pixel signal of a row selected by the control signal output from the row driver 160 to the readout block 190.

The column driver 165 may generate a plurality of control signals according to the control of the timing generator 170 and may control the operation of the readout block 190.

The timing generator 170 may generate a control signal or a clock signal to be applied to the row driver 160 and the column driver 165 using a control signal and a clock signal received from an external device (e.g., a host). In other words, the timing generator 170 may apply the control signal or the clock signal to the row driver 160 and the column driver 165 to control the operations or timing of the row driver 160 and the column driver 165. The control register block 180 operates according to the control of a camera control unit 210 and may store or buffer the control signal and the clock signal.

The readout block 190 reads out pixel signals of pixels included in each of a plurality of pixel groups based on pixel position information corresponding to each pixel group.

The image processor 200 may output an image sensed and output by the image sensor 100 to the display unit 300. The image processor 200 may include the camera control unit 210, a line memory 220, an image signal processor (ISP) 230, and a personal computer interface (PC I/F) 240.

The camera control unit 210 controls the control register block 180. The camera control unit 210 may control the image sensor 100 and more specifically the control register block 180 using an inter-integrated circuit (I²C), but the scope of the inventive concepts are not restricted thereto.

The line memory 220 may temporarily store a pixel signal and adjacent pixel signals and output them to the ISP 230 so that the pixel signals output from the readout block 190 in row units are sequentially processed. At this time, the line memory 220 may be implemented as dynamic random access memory (DRAM), but the inventive concept is not restricted to this example. Although the line memory 220 and the ISP 230 are implemented separately in the embodiments illustrated in FIG. 1, the inventive concepts are not restricted to the current embodiments and the line memory 220 may be implemented within the ISP 230 in other embodiments.

The ISP 230 processes a pixel signal output from the line memory 220 into image data of a form that people can view when displayed on the display unit 300, and outputs the image data to the display unit 300 through the PC I/F 240. The ISP 230 may also correct an image distorted by the lens 500 and output the corrected image signal to the PC I/F 240. For this correction, the ISP 230 may be configured to include a distortion corrector 232. The ISP 230 is implemented in a chip separated from the image sensor 100. Alternatively, the ISP 230 and the image sensor 100 may be integrated into a single chip.

The display unit 300 may be any device that can output an image. For instance, the display unit 300 may be implemented as or part of a computer, a mobile phone, a smart phone, a tablet, or any other image output terminal.

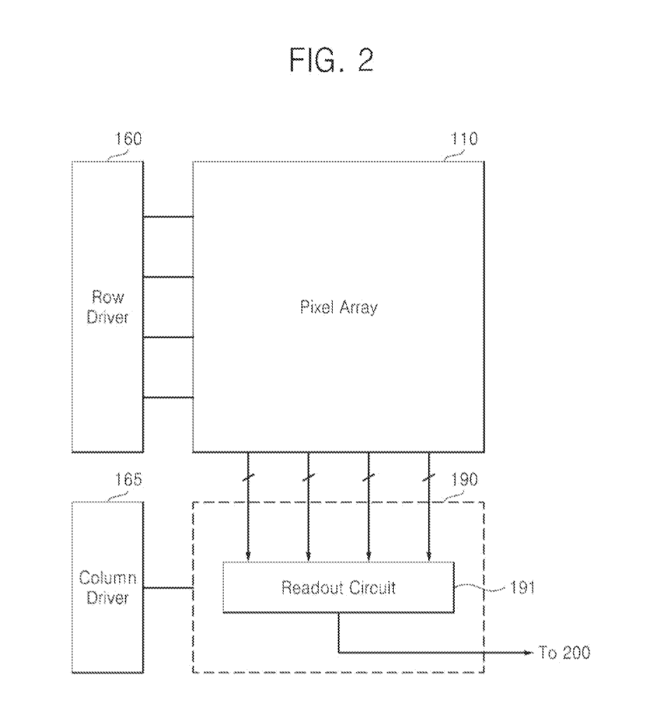

FIG. 2 is a block diagram showing the readout block 190 illustrated in FIG. 1. Referring to FIGS. 1 and 2, the pixel array 110 may output a plurality of pixel signals based on a control signal (not shown) output from the row driver 160.

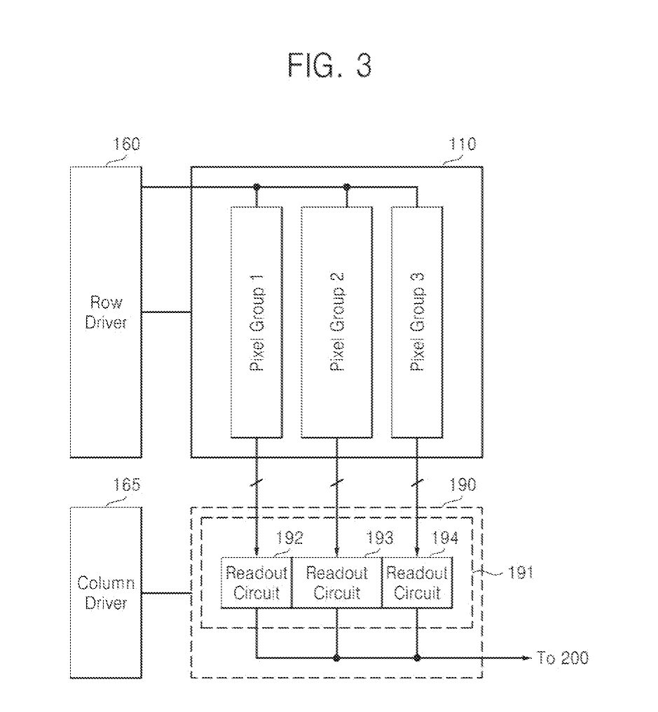

The readout block 190 may include a readout circuit unit 191 including a plurality of readout circuits. The readout circuit unit 191 may receive and store pixel signals from a plurality of pixel groups and may sequentially output the pixel signals to the image processor 200 according to a column selection signal (not shown) output from the column driver 165. Such readout block 190 is exemplified in FIG. 3.

FIG. 3 is a block diagram showing a connection between the pixel array 110 and the readout block 190 illustrated in FIG. 2 according to some embodiments of the inventive concepts. The image processing system 10 including the image sensor 100 having the structure illustrated in FIG. 3 may be used when an image output terminal is equipped with a lens. The lens may be, for example, a wide-angle lens or a fisheye lens.

Referring to FIGS. 1 through 3, the pixel array 110 may include a plurality of pixel groups 1, 2, and 3. The pixel array 110 includes three pixel groups in the embodiment illustrated in FIG. 3 for clarity of the description; however, the inventive concepts are not limited to three pixel groups.

Each of the pixel groups 1 through 3 may include pixels corresponding to at least two row lines and may be driven by a control signal (not shown) output from the row driver 160 to output a plurality of pixel signals. The row lines corresponding to the first and third pixel groups 1 and 3 may correspond to the fringe of an image captured through the lens 500 and the row lines corresponding to the second pixel group 2 may correspond to the center of the image.

The row lines may be differently spaced in two or more of the first through third pixel groups 1 through 3. For instance, the gap between the row lines in the first and third pixel groups 1 and 3 may be greater than the gap between the row lines in the second pixel group 2.

The readout circuit unit 191 includes a plurality of readout circuits 192, 193, and 194 respectively connected to the first through third pixel groups 1 through 3. The readout circuits 192, 193, and 194 may receive and store pixel signals from the first through third pixel groups 1 through 3, respectively, and may sequentially output the pixel signals to the line memory 220 according to a column selection signal (not shown) output from the column driver 165.

The line memory 220 may temporarily store the pixel signals received from the readout circuits 192 through 194 and may output the pixel signals to the ISP 230. The ISP 230 may include a distortion corrector 232 that eliminates distortion in the pixel signals received from the readout circuits 192 through 194 based on a desired (or, alternatively a predetermined) algorithm. The distortion corrector 232 may apply different compensation values to distortion in pixel signals corresponding to the center of an image captured through the lens 500 than to distortion in pixel signals corresponding to the fringe of the image based on the algorithm, thereby correcting the distortions.

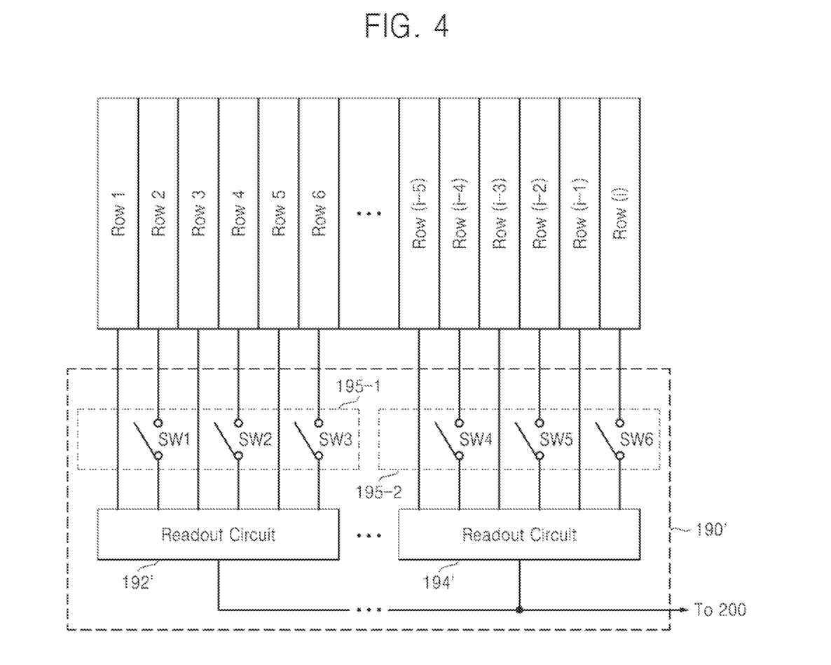

FIG. 4 is a block diagram showing a connection between the pixel array 110 and a readout block 190′ according to another embodiment of the inventive concepts. The image processing system 10 including the image sensor 100 having the structure illustrated in FIG. 4 may be used when an image output terminal has a replaceable lens.

Row lines Row1 through Row6 and Row(i-5) through Row(i) illustrated in FIG. 4 correspond to the fringe of an image captured through the lens 500. The row lines may be paired and one row line in a pair of row lines may be connected to a readout circuit. Although not shown in FIG. 4, row lines corresponding to the center of the image captured through the lens 500 may be directly connected to a readout circuit. The readout block 190′ may include a first switching unit 195-1 between the row lines Row1 through Row6 and a first readout circuit 192′ associated therewith. The readout block 190′ may include a second switching unit 195-2 between the row lines Row(i-5) through Row(i) and a third readout circuit 194′ associated therewith. A second readout circuit (not shown) may be connected with the seventh through (i-6)th row lines associated with center of the image in the same manner as shown in FIG. 3.

The first switching unit 195-1 may include first through third switches SW1, SW2, and SW3 and the second switching unit 195-2 may include fourth through sixth switches SW4, SW5, and SW6. The first through sixth switches SW1 through SW6 may be controlled according to a switching control signal (not shown) output from the column driver 165. First through third switches SW1 to SW3 selectively connect the second, fourth and sixth row lines, respectively, to the first readout circuit 192′; and the fourth through sixth switches SW4 to SW6 selectively connect the (i-4)^{th}, (i-2)^{th} and i^{th} row lines, respectively, to the third readout circuit 194′.

When a switching control signal (not shown) is output at a high level from the column driver 165, the first to sixth switches SW1 to SW6 close and the first and third readout circuits 192′ and 194′ may receive and store all pixel signals output from the associated row lines of the pixel array 110. However, when the switching control signal is output at a low level from the column driver 165, the first to sixth switches SW1 to SW6 open and the first and third readout circuits 192′ and 194′ may receive and store only some of the pixel signals output from the associated row lines of the pixel array 110. Namely, the first readout circuit 192′ does not receive the pixel signals from the second, fourth and sixth row lines; and the third readout circuit 194′ does not receive the pixel signals from the (i-4)^{th}, (1-2)^{th} and i^{th} row lines.

Like in the embodiments illustrated in FIG. 3, the first readout circuit 192′ and the third readout circuit 194′ may sequentially output the pixel signals stored therein to the line memory 220 according to a column selection signal (not shown) output from the column driver 165. Then, the line memory 220 may temporarily store the pixel signals from the first readout circuit 192′ and the third readout circuit 194′ and may output the pixel signals stored therein to the ISP 230. The line memory 220 may also temporarily store the pixel signals from the second readout circuit (now shown).

In other words, in an image processing system with a replaceable lens, the column driver 165 may control the first through sixth switches SW1 through SW6 to be open when a fisheye lens is mounted on the image processing system and may control the first through sixth switches SW1 through SW6 to be closed when a normal lens is mounted.

Although the row lines are alternately skipped in the embodiments illustrated in FIG. 4, the inventive concepts are not restricted to these embodiments. In other embodiments, skipping may occur every two or more row lines. Therefore, a size or capacity of the line memory 220 that stores pixel signals output from the readout block 190′ may be reduced or minimized.

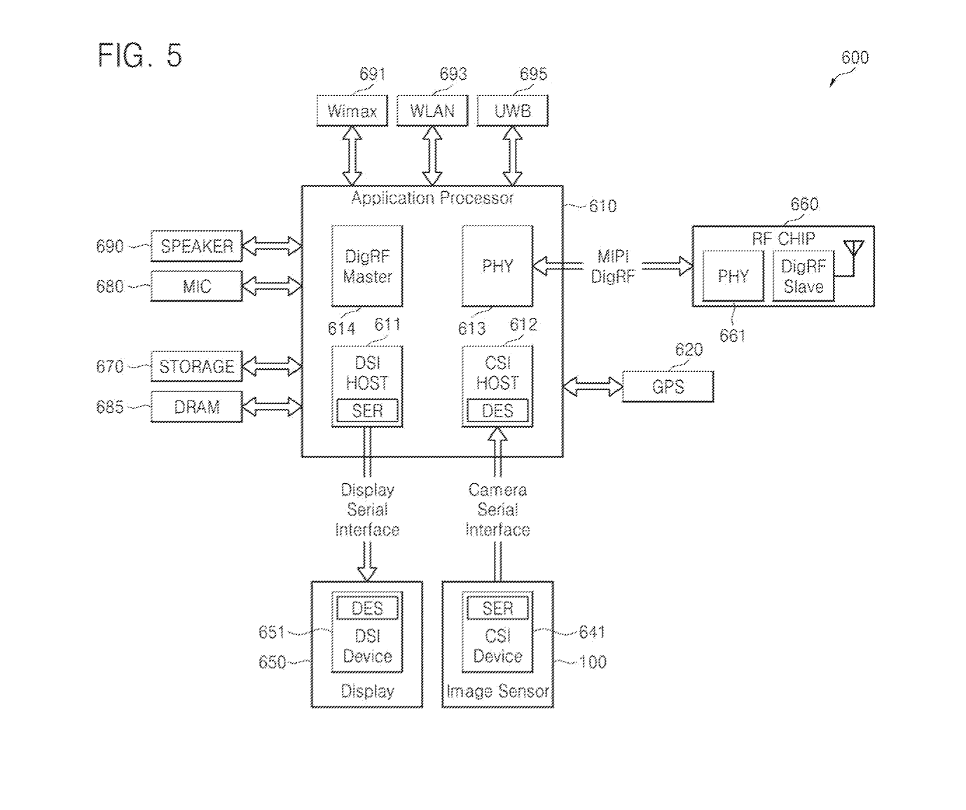

FIG. 5 is a block diagram of an electronic system including an image sensor illustrated in FIG. 1 according to some embodiments of the inventive concepts. Referring to FIGS. 1 and 5, the electronic system 600 may be implemented by a data processing apparatus, such as a mobile phone, a personal digital assistant (PDA), a portable media player (PMP), an IP TV, or a smart phone that can use or support the MIPI interface.

The electronic system 600 includes the image sensor 100, an application processor 610 and a display 650.

A camera serial interface (CSI) host 612 included in the application processor 610 performs serial communication with a CSI device 641 included in the image sensor 100 through CSI, and is configured to control the image sensor 100. For example, an optical de-serializer (DES) may be implemented in the CSI host 612, and an optical serializer (SER) may be implemented in the CSI device 641.

A display serial interface (DSI) host 611 included in the application processor 610 performs serial communication with a DSI device 651 included in the display 650 through DSI. For example, an optical serializer may be implemented in the DSI host 611, and an optical de-serializer may be implemented in the DSI device 651.

The electronic system 600 may also include a radio frequency (RF) chip 660, which communicates with the application processor 610. A physical layer (PHY) 613 of the electronic system 600 and a PHY 661 of the RF chip 660 communicate data with each other according to a MIPI DigRF standard. The application processor 610 may further include a DigRF master 614 controlling data transmission according to a MIPI DigRF of PHY 613.

The electronic system 600 may further include at least one element among a GPS 620, a storage device 670, a microphone 680, a DRAM 685 and a speaker 690. The electronic system 600 may communicate using Wimax (World Interoperability for Microwave Access) 691, WLAN (Wireless LAN) 693, UWB (Ultra Wideband) 695, etc. The structure and interface of the electronic system 600 given above are just some examples, and embodiments of the inventive concepts are not restricted to them.

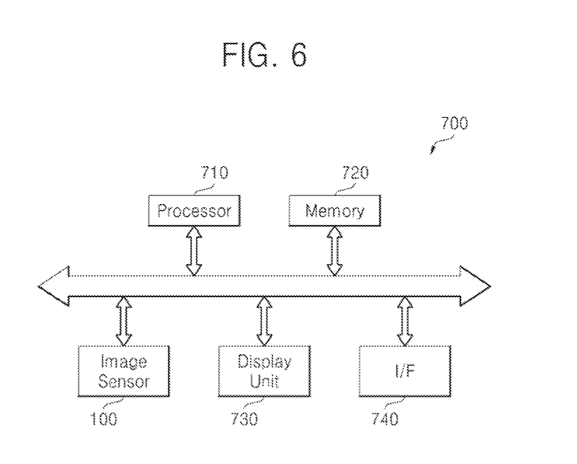

FIG. 6 is a block diagram of an electronic system including an image sensor illustrated in FIG. 1 according to another embodiment of the inventive concepts. Referring to FIGS. 1 and 6, the electronic system 700 includes the image sensor 100, a processor 710, a memory 720, a display unit 730 and an interface 740.

The processor 710 may control the operation of the image sensor 100. For example, the processor 710 may process pixel signals output from the image sensor 100 and generate image data.

The memory 720 may store program for controlling the image sensor 100 and the image data generated by the processor 710. The processor 710 may execute the program stored in the memory 720. For example, the memory 720 may be implemented by a volatile or non-volatile memory.

The display unit 730 may display the image data output from the processor 710 or the memory 720. For example, the display unit 730 may be a liquid crystal display (LCD), a light emitting diode (LED) display, an organic LED (OLED) display, an active matrix organic light emitting diodes (AMOLED) display or a flexible display.

The interface 740 may be implemented as an interface for inputting and outputting the image data. For example, the interface 740 may be implemented by a wireless interface.

As described above, according to some embodiments of the inventive concepts, an image sensor and an image processing system including the same perform readout on the fringe of an image at a wider interval than on the center of the image, thereby reducing a required capacity of line memory or amount of line memory used.

While the inventive concepts have been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. An image sensor comprising:
a plurality of pixel groups each of which comprises pixels corresponding to at least two row lines among a plurality of row lines in a pixel array;
a readout block configured to read out pixel signals output from the pixels in each of the pixel groups; and
a row driver configured to control an operation of the pixel groups,
wherein the row lines are differently spaced according to position information of the pixels.

2. The image sensor of claim 1, wherein the pixel groups comprise a first pixel group and a second pixel group and a gap between row lines in the first pixel group is wider than a gap between row lines in the second pixel group.

3. The image sensor of claim 2, wherein the row lines corresponding to the first pixel group correspond to a fringe of an image picked up by a lens and the row lines corresponding to the second pixel group correspond to a center of the image.

4. An image processing system comprising:
the image sensor of claim 1; and
an image processor configured to control an operation of the image sensor.

5. The image processing system of claim 4, wherein the image processor comprises a distortion corrector configured to eliminate distortion in pixel signals output from the readout block and the distortion corrector is configured to correct the distortion in the pixel signals using different compensation values according to the position information of the pixel signals based on an algorithm.

6. The image processing system of claim 4, wherein the image processing system is a mobile telephone.

7. An image sensor comprising:
a plurality of pixel groups each of which comprises pixels corresponding to at least two row lines among a plurality of row lines in a pixel array;
a readout block configured to read out pixel signals output from the pixels in each of the pixel groups; and
a column driver configured to control an operation of the readout block,
wherein the readout block controls readout of the pixel signals based on position information of the pixels.

8. The image sensor of claim 7, wherein the pixel groups comprise a first pixel group and a second pixel group, the readout block comprises a switching unit between row lines corresponding to the first pixel group and a first readout circuit, and row lines corresponding to the second pixel group are directly connected to a second readout circuit.

9. The image sensor of claim 8, wherein the switching unit comprises at least two switches and at least one of at least two row lines among the row lines corresponding to the first pixel group is respectively connected to the first readout circuit through a respective one of the at least two switches.

10. The image sensor of claim 9, wherein the row lines corresponding to the first pixel group correspond to a fringe of an image picked up by a lens and the row lines corresponding to the second pixel group correspond to a center of the image.

11. The image sensor of claim 10, wherein the column driver outputs a switch control signal for turning off the at least two switches when the lens is a fisheye lens and the column driver outputs a switch control signal for turning on the at least two switches when the lens is a normal lens.

12. An image processing system comprising:
the image sensor of claim 7; and
an image processor configured to control an operation of the image sensor.

13. The image processing system of claim 12, wherein the image processor comprises a distortion corrector configured to eliminate distortion in pixel signals output from the readout block and the distortion corrector is configured to correct the distortion in the pixel signals using different compensation values according to the position information of the pixel signals based on an algorithm.

14. The image processing system of claim 13, wherein the image processing system is a digital single-lens reflex (DSLR) camera.

15. An image sensor, comprising:
a first group of pixels;
a second group of pixels, the second group of pixels being in a different location of a pixel array than the first group of pixels;
a plurality of row lines in the pixel array;
a readout block configured to readout pixel signals output from the pixel array; and
one of (1) the plurality of row lines and (2) the readout block have a different structure associated with the first group of pixels than the second group of pixels.

16. The image sensor of claim 15, wherein row lines of the plurality of row lines associated with the first group of pixels are spaced apart wider than row lines of the plurality of the row lines associated with the second group of pixels.

17. The image sensor of claim 16, wherein the row lines associated with the first group of pixels correspond to a fringe of an image picked up by a lens and the row lines associated with the second group of pixels correspond to a center of the image.

18. The image sensor of claim 15, wherein the readout block comprises:
a first readout circuit associated with the first group of pixels;
a second readout circuit associated with the second group of pixels, the row lines associated with the second group of pixels being directly connected to the second readout circuit; and
a switching structure configured to selectively connect some of the row lines associated with the first group of pixels to the first readout circuit.

19. The image sensor of claim 18, wherein the row lines associated with the first group of pixels correspond to a fringe of an image picked up by a lens and the row lines associated with the second group of pixels correspond to a center of the image.

20. An image processing system comprising:
the image sensor of claim 15; and
an image processor configured to control an operation of the image sensor.
